(19) United States
(12) Patent Application Publication
(10) Pub. No.: US 2023/0014191 A1
(43) Pub. Date: Jan. 19, 2023

(54) SELF-CLEANING METHODS FOR AN INDOOR GARDENING APPLIANCE

(71) Applicant: Haier US Appliance Solutions, Inc., Wilmington, DE (US)

(72) Inventors: Louis A. Wantland, Louisville, KY (US); Olivia Ryan Didat, Floyds Knobs, IN (US); Santosh Kumar, Hyderabad (IN); Brian Allgeier, Louisville, KY (US); Matthew R. Hunter, Louisville, KY (US)

(21) Appl. No.: 17/377,680

(22) Filed: Jul. 16, 2021

(51) Int. Cl. A01G 31/02; B08B 3/08; G05D 7/06

(52) U.S. Cl. CPC A01G 31/02; B08B 3/08; G05D 7/0676; A01G 2031/006

(57) ABSTRACT

An indoor gardening appliance includes a grow module positioned within a grow chamber for receiving one or more plant pods. The indoor gardening system includes a hydration system including a water supply for providing a flow of water into a mixing tank and a discharge nozzle for selectively discharging the flow of water into the grow chamber. The indoor gardening appliance further includes a cleaning assembly fluidly coupled to the hydration system for selectively discharging a cleaning agent into the flow of water to create a cleaning solution to facilitate a self-clean cycle.

### FIELD OF THE INVENTION

The present subject matter relates generally to systems for gardening plants indoors, and more particularly, to systems and methods for cleaning an indoor gardening appliance.

### BACKGROUND OF THE INVENTION

Conventional indoor garden centers include a cabinet defining a grow chamber having a number of trays or racks positioned therein to support seedlings or plant material, e.g., for growing herbs, vegetables, or other plants in an indoor environment. In addition, such indoor garden centers may include an environmental control system that maintains the growing chamber at a desired temperature or humidity. Certain indoor garden centers may also include hydration systems for watering the plants and/or artificial lighting systems that provide the light necessary for such plants to grow.

Notably, as plants grow within indoor garden centers, there is commonly a build-up of dead organic matter on the roots, possible bacteria, mold, algae, and other contaminants. Additionally, scale or other “salts” may build up, particularly in narrow openings such as various spray nozzles. Failure to properly remove these byproducts may result in mold, mildew, or foul smells, or may otherwise negatively impact the appearance and/or performance of the indoor garden center. Thus, it may be desirable to remove the build-up of these undesirable contaminants or products, particularly in a manner that avoids the use of harsh chemicals or other sanitization sources that may be hazardous to humans, whether through direct exposure or secondary exposure by consuming plants sanitized using such sanitization sources.

Accordingly, a gardening appliance including features and operating methods for performing cleaning cycles would be desirable. More specifically, a method for initiating a self-clean cycle at desirable times would be particularly beneficial.

### BRIEF DESCRIPTION OF THE INVENTION

Aspects and advantages of the invention will be set forth in part in the following description, or may be apparent from the description, or may be learned through practice of the invention.

In one exemplary embodiment, an indoor gardening appliance is provided, including a liner positioned within a cabinet and defining a grow chamber, a grow module mounted within the liner and defining a plurality of apertures for receiving one or more plant pods, a hydration system comprising a water supply for providing a flow of water and a discharge nozzle for selectively discharging the flow of water into the grow chamber, and a cleaning assembly fluidly coupled to the hydration system for selectively discharging a cleaning agent into the flow of water to create a cleaning solution to facilitate a self-clean cycle.

In another exemplary embodiment, a hydration system for an indoor gardening appliance is provided. The indoor gardening appliance includes a cabinet defining a grow chamber for receiving plants. The hydration system includes a mixing tank fluidly coupled to a water supply for receiving a flow of water, a discharge nozzle for selectively discharging the flow of water into the grow chamber, and a cleaning assembly. The cleaning assembly includes one or more cartridges containing a cleaning agent and an injection mechanism for selectively discharging the cleaning agent from the one or more cartridges into the flow of water to create a cleaning solution to facilitate a self-clean cycle.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a gardening appliance according to an exemplary embodiment of the present subject matter.

FIG. 2 depicts a front view of the exemplary gardening appliance of FIG. 1 with the doors open according to an exemplary embodiment of the present subject matter.

FIG. 3 is a cross sectional view of the exemplary gardening appliance of FIG. 1, taken along Line 3-3 from FIG. 2 with an internal divider removed for clarity.

FIG. 4 is a top perspective view of the exemplary gardening appliance of FIG. 1, with the top panel of the cabinet removed to reveal a rotatable grow module according to an exemplary embodiment of the present subject matter.

FIG. 5 provides a perspective cross sectional view of the exemplary gardening appliance of FIG. 1 according to another exemplary embodiment of the present subject matter.

FIG. 6 provides a perspective view of the grow module of the exemplary gardening appliance of FIG. 1 according to another exemplary embodiment of the present subject matter.

FIG. 7 provides a perspective cross sectional view of the exemplary grow module of FIG. 6 according to another exemplary embodiment of the present subject matter.

FIG. 8 provides a top cross-sectional view of the exemplary grow module of FIG. 6 according to another exemplary embodiment of the present subject matter.

FIG. 9 provides a schematic view of a hydration system and cleaning assembly of the exemplary gardening appliance of FIG. 1 according to an exemplary embodiment of the present subject matter.

Repeat use of reference characters in the present specification and drawings is intended to represent the same or analogous features or elements of the present invention.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, terms of approximation, such as “approximately,” “substantially,” or “about,” refer to being within a ten percent (10%) margin of error of the stated value. Moreover, as used herein, the terms “first,” “second,” and “third” may be used interchangeably to distinguish one component from another and are not intended to signify location or importance of the individual components. The terms “upstream” and “downstream” refer to the relative direction with respect to fluid flow in a fluid pathway. For example, “upstream” refers to the direction from which the fluid flows, and “downstream” refers to the direction to which the fluid flows.

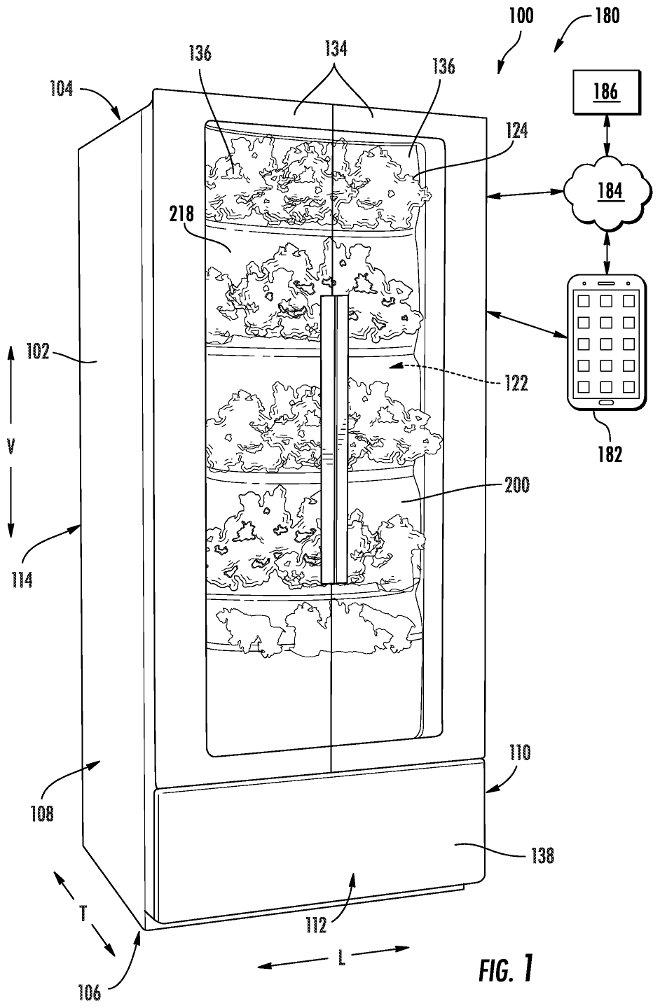

FIG. 1 provides a front view of a gardening appliance 100 according to an exemplary embodiment of the present subject matter. According to exemplary embodiments, gardening appliance 100 may be used as an indoor garden center for growing plants. It should be appreciated that the embodiments described herein are intended only for explaining aspects of the present subject matter. Variations and modifications may be made to gardening appliance 100 while remaining within the scope of the present subject matter.

Gardening appliance 100 includes a housing or cabinet 102 that extends between a top 104 and a bottom 106 along a vertical direction V, between a first side 108 and a second side 110 along a lateral direction L, and between a front side 112 and a rear side 114 along a transverse direction T. Each of the vertical direction V, lateral direction L, and transverse direction T are mutually perpendicular to one another and form an orthogonal direction system.

Gardening appliance 100 may include an insulated liner 120 positioned within cabinet 102. Liner 120 may at least partially define a temperature controlled chamber, referred to herein generally as a grow chamber 122, within which plants 124 may be grown. Although gardening appliance 100 is referred to herein as growing plants 124, it should be appreciated that other organisms or living things may be grown or stored in gardening appliance 100. For example, algae, fungi (e.g., including mushrooms), or other living organisms may be grown or stored in gardening appliance 100. The specific application described herein is not intended to limit the scope of the present subject matter.

Cabinet 102, or more specifically, liner 120 may define a substantially enclosed back region or portion 130. In addition, cabinet 102 and liner 120 may define a front opening, referred to herein as front display opening 132, through which a user of gardening appliance 100 may access grow chamber 122, e.g., for harvesting, planting, pruning, or otherwise interacting with plants 124. According to an exemplary embodiment, enclosed back portion 130 may be defined as a portion of liner 120 that defines grow chamber 122 proximate rear side 114 of cabinet 102. In addition, front display opening 132 may generally be positioned proximate or coincide with front side 112 of cabinet 102.

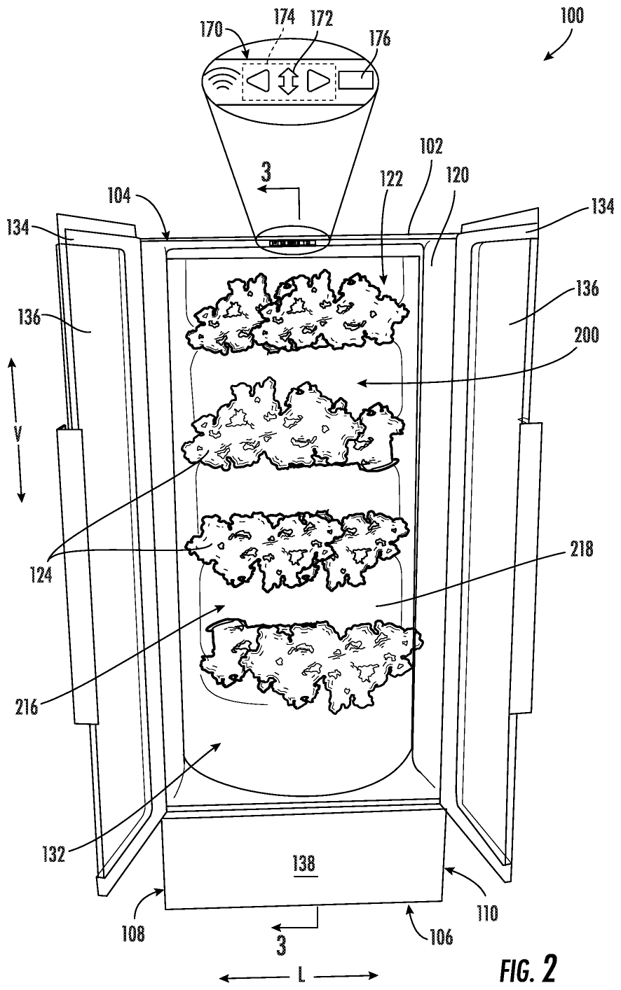

Gardening appliance 100 may further include one or more doors 134 that are rotatably mounted to cabinet 102 for providing selective access to grow chamber 122. For example, FIG. 1 illustrates doors 134 in the closed position such that they may help insulate grow chamber 122. By contrast, FIG. 2 illustrates doors 134 in the open positioned for accessing grow chamber 122 and plants 124 stored therein. Doors 134 may further include a transparent window 136 through which a user may observe plants 124 without opening doors 134.

Although doors 134 are illustrated as being rectangular and being mounted on front side 112 of cabinet 102 in FIGS. 1 and 2, it should be appreciated that according to alternative embodiments, doors 134 may have different shapes, mounting locations, etc. For example, doors 134 may be curved, may be formed entirely from glass, etc. In addition, doors 134 may have integral features for controlling light passing into and/or out of grow chamber 122, such as internal louvers, tinting, UV treatments, polarization, etc. One skilled in the art will appreciate that other chamber and door configurations are possible and within the scope of the present invention.

According to the illustrated embodiment, cabinet 102 further defines a drawer 138 positioned proximate bottom 106 of cabinet 102 and being slidably mounted to cabinet 102 for providing convenient storage for plant nutrients, system accessories, water filters, etc. In addition, behind drawer 138 is a mechanical compartment 140 for receipt of an environmental control system including a sealed system for regulating the temperature within grow chamber 122, as described in more detail below.

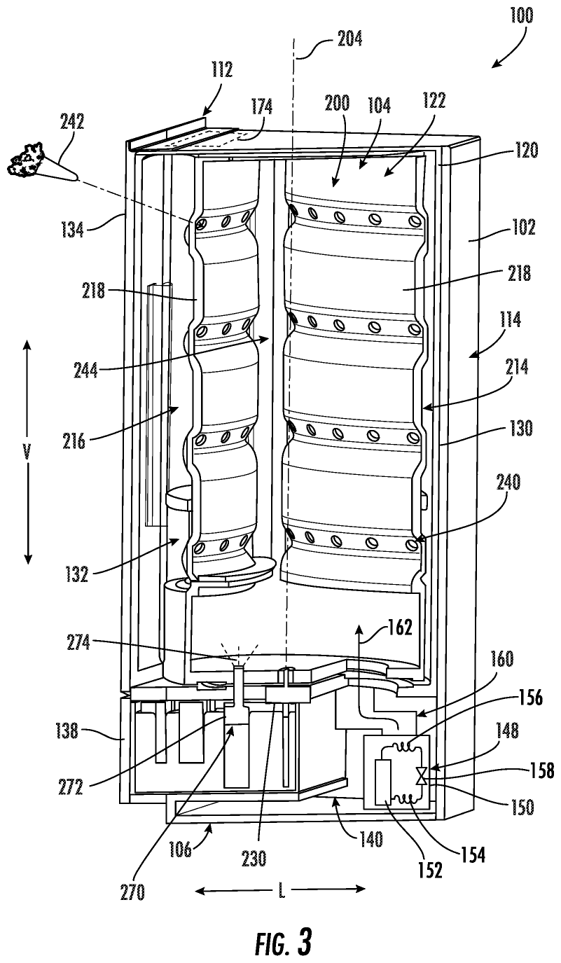

FIG. 3 provides a schematic view of certain components of an environmental control system 148 that may be used to regulate a temperature within grow chamber 122. Specifically, environmental control system 148 may include a sealed system 150, a duct system 160, and a hydration system 270, or any other suitable components or subsystems for regulating an environment within grow chamber 122, e.g., for facilitating improved or regulated growth of plants 124 positioned therein. Specifically, FIG. 3 illustrates sealed system 150 within mechanical compartment 140. Although an exemplary sealed system is illustrated and described herein, it should be appreciated that variations and modifications may be made to sealed system 150 while remaining within the scope of the present subject matter. For example, sealed system 150 may include additional or alternative components, different ducting configurations, etc.

As shown, sealed system 150 includes a compressor 152, a first heat exchanger or evaporator 154 and a second heat exchanger or condenser 156. As is generally understood, compressor 152 is generally operable to circulate or urge a flow of refrigerant through sealed system 150, which may include various conduits which may be utilized to flow refrigerant between the various components of sealed system 150. Thus, evaporator 154 and condenser 156 may be between and in fluid communication with each other and compressor 152.

During operation of sealed system 150, refrigerant flows from evaporator 154 and to compressor 152, and compressor 152 is generally configured to direct compressed refrigerant from compressor 152 to condenser 156. For example, refrigerant may exit evaporator 154 as a fluid in the form of a superheated vapor. Upon exiting evaporator 154, the refrigerant may enter compressor 152, which is operable to compress the refrigerant. Accordingly, the pressure and temperature of the refrigerant may be increased in compressor 152 such that the refrigerant becomes a more superheated vapor.

Condenser 156 is disposed downstream of compressor 152 and is operable to reject heat from the refrigerant. For example, the superheated vapor from compressor 152 may enter condenser 156 and transfer energy to air surrounding condenser 156 (e.g., to create a flow of heated air). In this manner, the refrigerant condenses into a saturated liquid and/or liquid vapor mixture. A condenser fan (not shown) may be positioned adjacent condenser 156 and may facilitate or urge the flow of heated air across the coils of condenser 156 (e.g., from ambient atmosphere) in order to facilitate heat transfer.

According to the illustrated embodiment, an expansion device or a variable electronic expansion valve 158 may be further provided to regulate refrigerant expansion. During use, variable electronic expansion valve 158 may generally expand the refrigerant, lowering the pressure and temperature thereof. In this regard, refrigerant may exit condenser 156 in the form of high liquid quality/saturated liquid vapor mixture and travel through variable electronic expansion valve 158 before flowing through evaporator 154. Variable electronic expansion valve 158 is generally configured to be adjustable, e.g., such that the flow of refrigerant (e.g., volumetric flow rate in milliliters per second) through variable electronic expansion valve 158 may be selectively varied or adjusted.

Evaporator 154 is disposed downstream of variable electronic expansion valve 158 and is operable to heat refrigerant within evaporator 154, e.g., by absorbing thermal energy from air surrounding the evaporator (e.g., to create a flow of cooled air). For example, the liquid or liquid vapor mixture refrigerant from variable electronic expansion valve 158 may enter evaporator 154. Within evaporator 154, the refrigerant from variable electronic expansion valve 158 receives energy from the flow of cooled air and vaporizes into superheated vapor and/or high quality vapor mixture. An air handler or evaporator fan (not shown) is positioned adjacent evaporator 154 and may facilitate or urge the flow of cooled air across evaporator 154 in order to facilitate heat transfer. From evaporator 154, refrigerant may return to compressor 152 and the vapor-compression cycle may continue.

As explained above, environmental control system 148 includes a sealed system 150 for providing a flow of heated air or a flow cooled air throughout grow chamber 122 as needed. To direct this air, environmental control system 148 includes a duct system 160 for directing the flow of temperature regulated air, identified herein simply as flow of air 162 (see, e.g., FIG. 3). In this regard, for example, an evaporator fan can generate a flow of cooled air as the air passes over evaporator 154 and a condenser fan can generate a flow of heated air as the air passes over condenser 156.

These flows of air 162 are routed through a cooled air supply duct and/or a heated air supply duct (not shown), respectively. In this regard, it should be appreciated that environmental control system 148 may generally include a plurality of ducts, dampers, diverter assemblies, and/or air handlers to facilitate operation in a cooling mode, in a heating mode, in both a heating and cooling mode, or any other mode suitable for regulating the environment within grow chamber 122. It should be appreciated that duct system 160 may vary in complexity and may regulate the flows of air from sealed system 150 in any suitable arrangement through any suitable portion of grow chamber 122.

Gardening appliance 100 may include a control panel 170. Control panel 170 includes one or more input selectors 172, such as e.g., knobs, buttons, push buttons, touchscreen interfaces, etc. In addition, input selectors 172 may be used to specify or set various settings of gardening appliance 100, such as e.g., settings associated with operation of sealed system 150. Input selectors 172 may be in communication with a processing device or controller 174. Control signals generated in or by controller 174 operate gardening appliance 100 in response to input selectors 172. Additionally, control panel 170 may include a display 176, such as an indicator light or a screen. Display 176 is communicatively coupled with controller 174 and may display information in response to signals from controller 174. Further, as will be described herein, controller 174 may be communicatively coupled with other components of gardening appliance 100, such as e.g., one or more sensors, motors, or other components.

As used herein, “processing device” or “controller” may refer to one or more microprocessors or semiconductor devices and is not restricted necessarily to a single element. The processing device can be programmed to operate gardening appliance 100. The processing device may include, or be associated with, one or more memory elements (e.g., non-transitory storage media). In some such embodiments, the memory elements include electrically erasable, programmable read only memory (EEPROM). Generally, the memory elements can store information accessible processing device, including instructions that can be executed by processing device. Optionally, the instructions can be software or any set of instructions and/or data that when executed by the processing device, cause the processing device to perform operations.

Referring again to FIG. 1, a schematic diagram of an external communication system 180 will be described according to an exemplary embodiment of the present subject matter. In general, external communication system 180 is configured for permitting interaction, data transfer, and other communications between gardening appliance 100 and one or more external devices. For example, this communication may be used to provide and receive operating parameters, user instructions or notifications, performance characteristics, user preferences, or any other suitable information for improved performance of gardening appliance 100. In addition, it should be appreciated that external communication system 180 may be used to transfer data or other information to improve performance of one or more external devices or appliances and/or improve user interaction with such devices.

For example, external communication system 180 permits controller 174 of gardening appliance 100 to communicate with a separate device external to gardening appliance 100, referred to generally herein as an external device 182. As described in more detail below, these communications may be facilitated using a wired or wireless connection, such as via a network 184. In general, external device 182 may be any suitable device separate from gardening appliance 100 that is configured to provide and/or receive communications, information, data, or commands from a user. In this regard, external device 182 may be, for example, a personal phone, a smartphone, a tablet, a laptop or personal computer, a wearable device, a smart home system, or another mobile or remote device.

In addition, a remote server 186 may be in communication with gardening appliance 100 and/or external device 182 through network 184. In this regard, for example, remote server 186 may be a cloud-based server 186, and is thus located at a distant location, such as in a separate state, country, etc. According to an exemplary embodiment, external device 182 may communicate with a remote server 186 over network 184, such as the Internet, to transmit/receive data or information, provide user inputs, receive user notifications or instructions, interact with or control gardening appliance 100, etc. In addition, external device 182 and remote server 186 may communicate with gardening appliance 100 to communicate similar information.

In general, communication between gardening appliance 100, external device 182, remote server 186, and/or other user devices or appliances may be carried using any type of wired or wireless connection and using any suitable type of communication network, non-limiting examples of which are provided below. For example, external device 182 may be in direct or indirect communication with gardening appliance 100 through any suitable wired or wireless communication connections or interfaces, such as network 184. For example, network 184 may include one or more of a local area network (LAN), a wide area network (WAN), a personal area network (PAN), the Internet, a cellular network, any other suitable short- or long-range wireless networks, etc. In addition, communications may be transmitted using any suitable communications devices or protocols, such as via Wi-Fi®, Bluetooth®, Zigbee®, wireless radio, laser, infrared, Ethernet type devices and interfaces, etc. In addition, such communication may use a variety of communication protocols (e.g., TCP/IP, HTTP, SMTP, FTP), encodings or formats (e.g., HTML, XML), and/or protection schemes (e.g., VPN, secure HTTP, SSL).

External communication system 180 is described herein according to an exemplary embodiment of the present subject matter. However, it should be appreciated that the exemplary functions and configurations of external communication system 180 provided herein are used only as examples to facilitate description of aspects of the present subject matter. System configurations may vary, other communication devices may be used to communicate directly or indirectly with one or more associated appliances, other communication protocols and steps may be implemented, etc. These variations and modifications are contemplated as within the scope of the present subject matter.

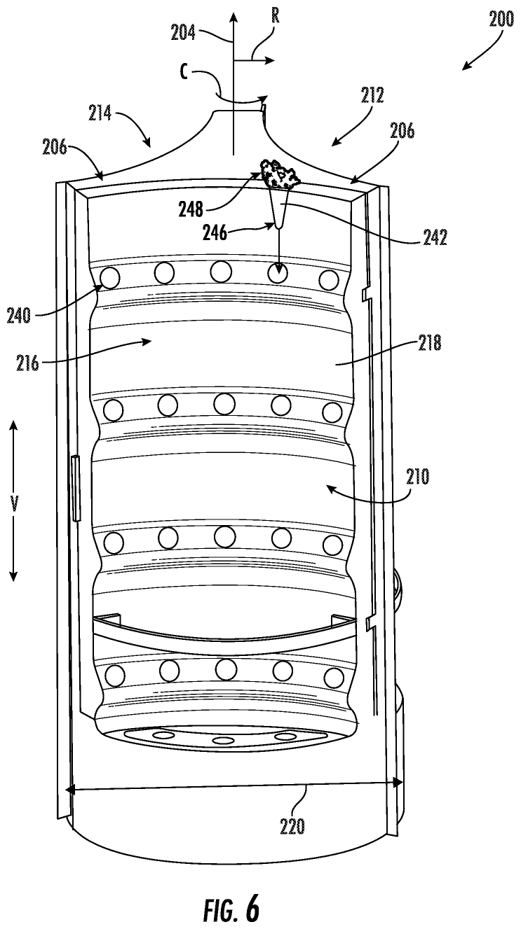

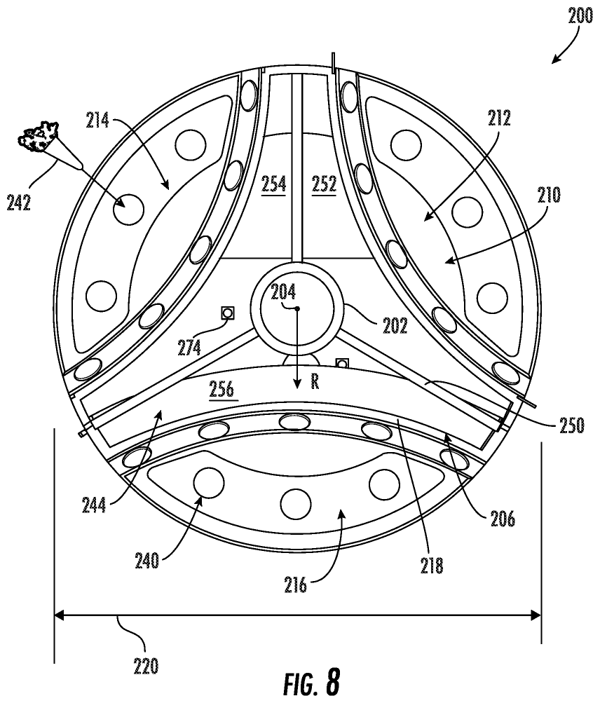

Referring now generally to FIGS. 1 through 8, gardening appliance 100 generally includes a rotatable carousel, referred to herein as a grow module 200 that is mounted within liner 120, e.g., such that it is within grow chamber 122. As illustrated, grow module 200 includes a central hub 202 that extends along and is rotatable about a central axis 204. Specifically, according to the illustrated embodiment, central axis 204 is parallel to the vertical direction V. However, it should be appreciated that central axis 204 could alternatively extend in any suitable direction, e.g., such as the horizontal direction. In this regard, grow module 200 generally defines an axial direction, i.e., parallel to central axis 204, a radial direction R that extends perpendicular to central axis 204, and a circumferential direction C that extends around central axis 204 (e.g. in a plane perpendicular to central axis 204).

Grow module 200 may further include a plurality of partitions 206 that extend from central hub 202 substantially along the radial direction R. In this manner, grow module 200 defines a plurality of chambers, referred to herein generally by reference numeral 210, by dividing or partitioning grow chamber 122. Referring specifically to a first embodiment of grow module 200 illustrated in FIGS. 1 through 8, grow module 200 includes three partitions 206 to define a first chamber 212, a second chamber 214, and a third chamber 216, which are circumferentially spaced relative to each other. In general, as grow module 200 is rotated within grow chamber 122, the plurality of chambers 210 define substantially separate and distinct growing environments, e.g., for growing plants 124 having different growth needs.

More specifically, partitions 206 may extend from central hub 202 to a location immediately adjacent liner 120. Although partitions 206 are described as extending along the radial direction, it should be appreciated that they need not be entirely radially extending. For example, according to the illustrated embodiment, the distal ends of each partition is joined with an adjacent partition using an arcuate wall 218, which is generally used to support plants 124.

Notably, it is desirable according to exemplary embodiments to form a substantial seal between partitions 206 and liner 120. Therefore, according to an exemplary embodiment, grow module 200 may define a grow module diameter 220 (e.g., defined by its substantially circular footprint formed in a horizontal plane). Similarly, enclosed back portion 130 of liner 120 may be substantially cylindrical and may define a liner diameter 222. In order to prevent a significant amount of air from escaping between partitions 206 and liner 120, liner diameter 222 may be substantially equal to or slightly larger than grow module diameter 220.

According to still other embodiments, grow module 200 may include one or more sealing elements 224 positioned on a radially distal end of each of partitions 206. In this regard, sealing elements 224 may extend from partitions 206 toward liner 120 to contact and seal against liner 120. For example, according to the illustrated embodiment, sealing elements 224 are wiper blades formed from silicone or another suitably resilient material. Thus, as grow module 200 rotates, sealing elements 224 slide against liner 120 to substantially seal each of the plurality of chambers 210. It should be appreciated that as used herein, the term “substantial seal” and the like is not intended to refer to a perfectly airtight junction. Instead, this term is generally used to refer to an environment which may be regulated independently of adjacent environments to a reasonable degree. For example, if plants 124 and the first chamber 212 prefer a 10° F. increase in temperature relative to plants 124 and second chamber 214, the substantial seal between these two chambers may facilitate such temperature difference.

Referring now specifically to FIG. 3, gardening appliance 100 may further include a motor 230 or another suitable driving element or device for selectively rotating grow module 200 during operation of gardening appliance 100. In this regard, according to the illustrated embodiment, motor 230 is positioned below grow module 200, e.g., within mechanical compartment 140, and is operably coupled to grow module 200 along central axis 204 for rotating grow module 200.

As used herein, “motor” may refer to any suitable drive motor and/or transmission assembly for rotating grow module 200. For example, motor 230 may be a brushless DC electric motor, a stepper motor, or any other suitable type or configuration of motor. For example, motor 230 may be an AC motor, an induction motor, a permanent magnet synchronous motor, or any other suitable type of AC motor. In addition, motor 230 may include any suitable transmission assemblies, clutch mechanisms, or other components.

According to an exemplary embodiment, motor 230 may be operably coupled to controller 174, which is programmed to rotate grow module 200 according to predetermined operating cycles, based on user inputs (e.g. via touch buttons 172), etc. In addition, controller 174 may be communicatively coupled to one or more sensors, such as temperature or humidity sensors, positioned within the various chambers 210 for measuring temperatures and/or humidity, respectively. Controller 174 may then operate motor 230 in order to maintain desired environmental conditions for each of the respective chambers 210. For example, as will be described in more detail below, gardening appliance 100 includes features for providing certain locations of gardening appliance 100 with light, temperature control, proper moisture, nutrients, and other requirements for suitable plant growth. Motor 230 may be used to position specific chambers 210 where needed to receive such growth requirements.

According to an exemplary embodiment, such as where three partitions 206 form three chambers 212-216, controller 174 may operate motor 230 to index grow module 200 sequentially through a number of preselected positions. More specifically, motor 230 may rotate grow module 200 in a counterclockwise direction (e.g. when viewed from a top of grow module 200) in 120° increments to move chambers 210 between sealed positions and display positions. As used herein, a chamber 210 is considered to be in a “sealed position” when that chamber 210 is substantially sealed between grow module 200 (i.e., central hub 202 and adjacent partitions 206) and liner 120. By contrast, a chamber 210 is considered to be in a “display position” when that chamber 210 is at least partially exposed to front display opening 132, such that a user may access plants 124 positioned within that chamber 210.

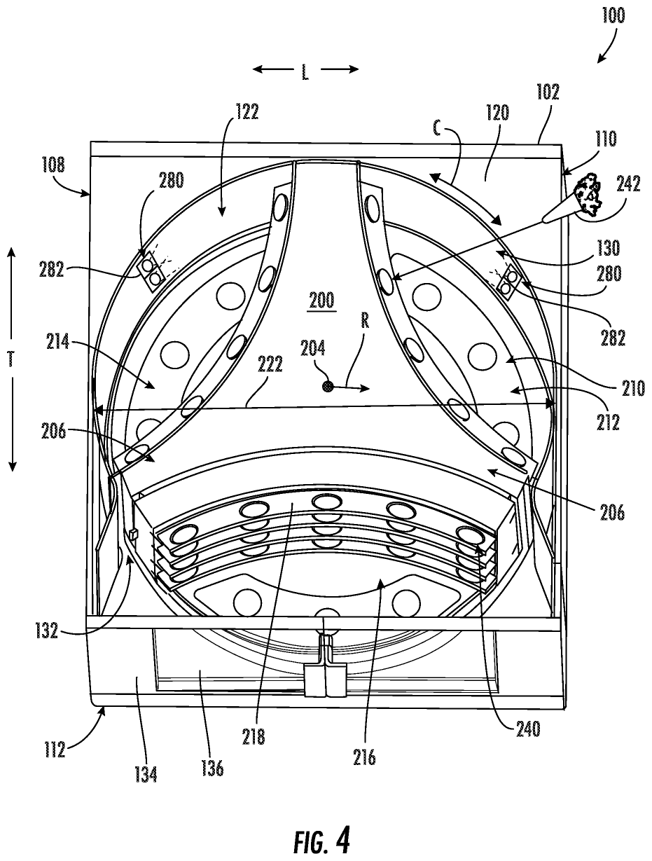

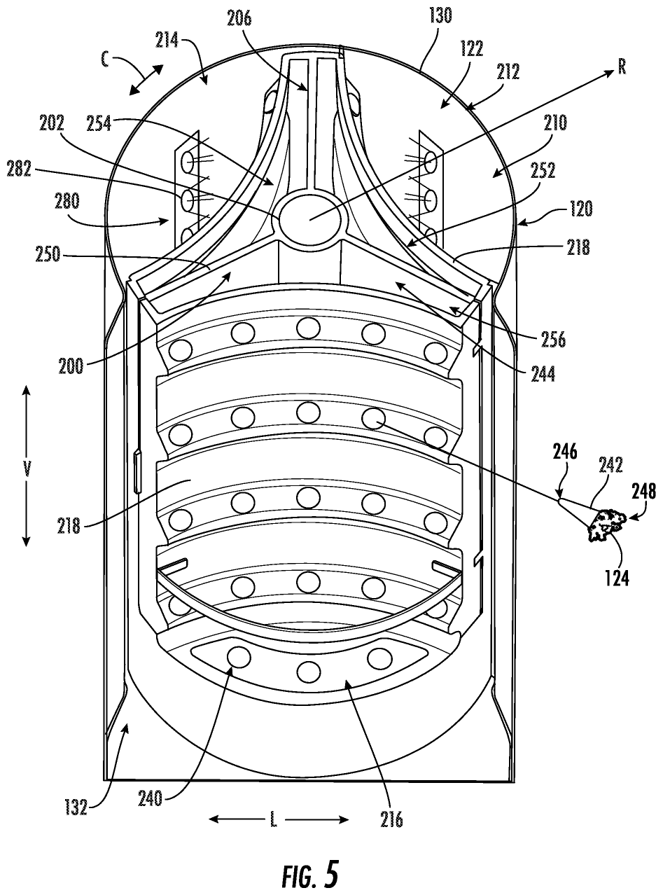

For example, as illustrated in FIGS. 4 and 5, first chamber 212 and second chamber 214 are both in a sealed position, whereas third chamber 216 is in a display position. As motor 230 rotates grow module 200 by 120 degrees in the counterclockwise direction, second chamber 214 will enter the display position, while first chamber 212 and third chamber 216 will be in the sealed positions. Motor 230 may continue to rotate grow module 200 in such increments to cycle grow chambers 210 between these sealed and display positions.

Referring now generally to FIGS. 4 through 8, grow module 200 will be described in more detail according to an exemplary embodiment of the present subject matter. As shown, grow module 200 defines a plurality of apertures 240 which are generally configured for receiving plant pods 242 into an internal root chamber 244. Plant pods 242 generally contain seedlings or other material for growing plants positioned within a mesh or other support structure through which roots of plants 124 may grow within grow module 200. A user may insert a portion of plant pod 242 (e.g., a seed end or root end 246) having the desired seeds through one of the plurality of apertures 240 into root chamber 244. A plant end 248 of the plant pod 242 may remain within grow chamber 210 such that plants 124 may grow from grow module 200 such that they are accessible by a user. In this regard, grow module 200 defines root chamber 244, e.g., within at least one of central hub 202 and the plurality of partitions 206. As will be explained below, water and other nutrients may be supplied to the root end 246 of plant pods 242 within root chamber 244. Notably, apertures 240 may be covered by a flat flapper seal (not shown) to prevent water from escaping root chamber 244 when no plant pod 242 is installed.

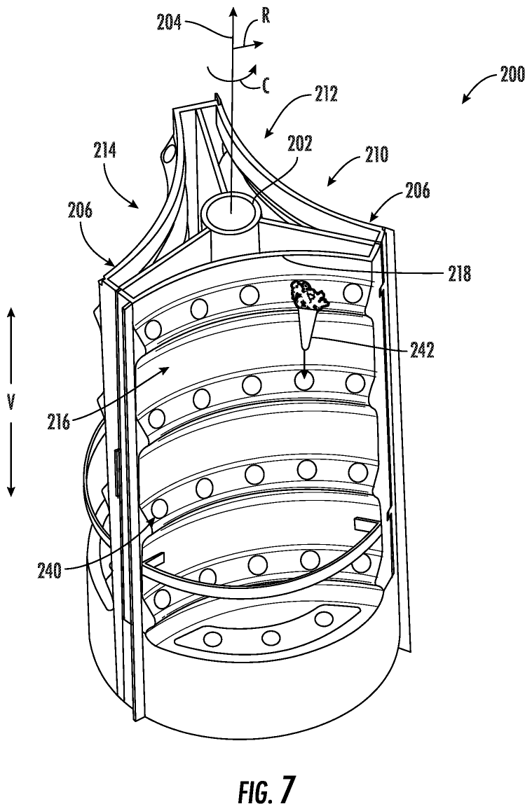

As best shown in FIGS. 5 and 7, grow module 200 may further include an internal divider 250 that is positioned within root chamber 244 to divide root chamber 244 into a plurality of root chambers, each of the plurality of root chambers being in fluid communication with one of the plurality of grow chambers 210 through the plurality of apertures 240. More specifically, according to the illustrated embodiment, internal divider 250 may divide root chamber 244 into a first root chamber 252, a second root chamber 254, and a third root chamber 256. According to an exemplary embodiment, first root chamber 252 may provide water and nutrients to plants 124 positioned in the first grow chamber 212, second root chamber 254 may provide water and nutrients to plants 124 positioned in the second grow chamber 214, and third root chamber 256 may provide water and nutrients to plants 124 positioned in the third grow chamber 216. In this manner, environmental control system 148 may control the temperature and/or humidity of each of the plurality of chambers 212-216 and the plurality of root chambers 252-256 independently of each other.

Environmental control system 148 may further include a hydration system 270 which is generally configured for providing water to plants 124 to support their growth. Specifically, according to the illustrated embodiment, hydration system 270 generally includes a water supply 272 and misting device 274 (e.g., such as a fine mist spray nozzle or nozzles). For example, water supply 272 may be a reservoir containing water (e.g., distilled water) or may be a direct connection municipal water supply. Misting device 274 may be positioned at a bottom of root chamber 244 and may be configured for charging root chamber 244 with mist for hydrating the roots of plants 124. Alternatively, misting devices 274 may pass through central hub 204 along the vertical direction V and periodically include a nozzle for spraying a mist or water into root chamber 244 or grow chamber 122. Because various plants 124 may require different amounts of water for desired growth, hydration system 270 may alternatively include a plurality of misting devices 274, e.g., all coupled to water supply 272, but being selectively operated to charge each of first root chamber 252, second root chamber 254, and third root chamber 256 independently of each other.

Notably, environmental control system 148 described above is generally configured for regulating the temperature and humidity (e.g., or some other suitable water level quantity or measurement) within one or all of the plurality of chambers 210 and/or root chambers 252-256 independently of each other. In this manner, a versatile and desirable growing environment may be obtained for each and every chamber 210.

Referring now for example to FIGS. 4 and 5, gardening appliance 100 may further include a light assembly 280 which is generally configured for providing light into selected grow chambers 210 to facilitate photosynthesis and growth of plants 124. As shown, light assembly 280 may include a plurality of light sources 282 stacked in an array, e.g., extending along the vertical direction V. For example, light sources 282 may be mounted directly to liner 120 within grow chamber 122, or may alternatively be positioned behind liner 120 such that light is projected through a transparent window or light pipe into grow chamber 122. The position, configuration, and type of light sources 282 described herein are not intended to limit the scope of the present subject matter in any manner.

Light sources 282 may be provided as any suitable number, type, position, and configuration of electrical light source(s), using any suitable light technology and illuminating in any suitable color. For example, according to the illustrated embodiment, light source 282 includes one or more light emitting diodes (LEDs), which may each illuminate in a single color (e.g., white LEDs), or which may each illuminate in multiple colors (e.g., multi-color or RGB LEDs) depending on the control signal from controller 174. However, it should be appreciated that according to alternative embodiments, light sources 282 may include any other suitable traditional light bulbs or sources, such as halogen bulbs, fluorescent bulbs, incandescent bulbs, glow bars, a fiber light source, etc.

According to an exemplary embodiment, light assembly 280 is positioned only within the enclosed back portion 130 of liner 120 such that only grow chambers 210 which are in a sealed position are exposed to light from light sources 282. Specifically, grow module 200 acts as a physical partition between light assemblies 280 and front display opening 132. In this manner, as illustrated in FIG. 5, no light may pass from first chamber 212 or second chamber 214 through grow module 200 and out front display opening 132. As grow module 200 rotates, two of the three grow chambers 210 will receive light from light assembly 280 at a time. According still other embodiments, a single light assembly may be used to reduce costs, whereby only a single grow chamber 210 will be lit at a single time.

Gardening appliance 100 and grow module 200 have been described above to explain an exemplary embodiment of the present subject matter. However, it should be appreciated that variations and modifications may be made while remaining within the scope of the present subject matter. For example, according to alternative embodiments, gardening appliance 100 may be a simplified to a two-chamber embodiment with a square liner 120 and a grow module 200 having two partitions 206 extending from opposite sides of central hub 202 to define a first grow chamber and a second grow chamber. According to such an embodiment, by rotating grow module 200 by 180 degrees about central axis 206, the first chamber may alternate between the sealed position (e.g., facing rear side 114 of cabinet 102) and the display position (e.g., facing front side 112 of cabinet 102). By contrast, the same rotation will move the second chamber from the display position to the sealed position.

According to still other embodiments, gardening appliance 100 may include a three chamber grow module 200 but may have a modified cabinet 102 such that front display opening 132 is wider and two of the three grow chambers 210 are displayed at a single time. Thus, first chamber 212 may be in the sealed position, while second chamber 214 and third chamber 216 may be in the display positions. As grow module 200 is rotated counterclockwise, first chamber 212 is moved into the display position and third chamber 216 is moved into the sealed position.

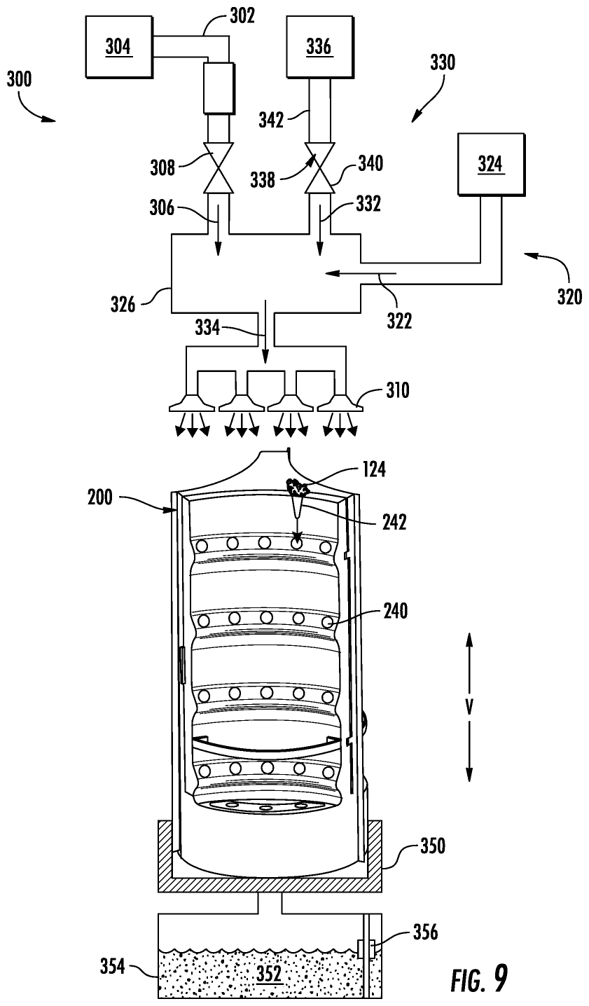

Referring now specifically to FIG. 9, gardening appliance 100 may further include a hydration system 300 that is generally configured for hydrating plants 124 within gardening appliance 100. In addition, as explained in more detail below, hydration system 300 may include features for performing cleaning cycles to sanitize or otherwise clean gardening appliance 100 and/or plants 124 positioned therein. In this regard, for example, hydration system 300 may be a part of or may entirely replace a hydration system 270 described above. Although an exemplary configuration and operation of hydration system 300 will be described below, it should be appreciated that variations and modifications may be made to such systems and methods while remaining within the scope of the present subject matter.

Although hydration system 300 is described herein as being used with gardening appliance 100, it should be appreciated that aspects of the present subject matter may be applied in any other suitable hydration system. For example, the hydration system 300 described herein may be used to provide hydrating water, nutrition, and/or cleaning spray in any other suitable application, in any other suitable appliance, etc. In addition, variations and modifications may be made to the exemplary constructions described herein while remaining within the scope of the present subject matter.

According to the illustrated embodiment, hydration system 300 includes a supply conduit 302 that is fluidly coupled to any suitable number and type of fluid supplies to provide water into gardening appliance 100. Specifically, according to an exemplary embodiment, hydration system 300 includes a water supply 304 for providing water such as pure tap water, distilled water, or water from any external fluid supply source. For example, water supply 304 may be a municipal water supply that provides a flow of pressurized water (e.g., identified in FIG. 9 as flow of water 306). According to still other embodiments, water supply 304 may include any other suitable sources of water, such as a water storage tank that may be filled by a user and that is contained within cabinet 102.

It should be appreciated that water supply 304 (or hydration system 300 more generally) may include any suitable pumps, flow regulating valves, or other flow regulating devices needed to regulate the flow of water 306. For example, according to exemplary embodiments, hydration system 300 may further include one or more valves positioned throughout hydration system 300 for regulating the flow of fluid therein. For example, as illustrated in FIG. 9, hydration system 300 includes a discharge valve 308 that is operably coupled to supply conduit 302.

Supply conduit 302 may generally be configured for providing a flow of water and/or other nutrients into grow chamber 122 and/or root chamber 244. Specifically, hydration system 300 further includes one or more discharge nozzles 310 that are in fluid communication with supply conduit 302 to selectively provide the flow of liquid through discharge nozzles 310 to hydrate and/or sanitize plants 124 or other portions of gardening appliance 100. According to an exemplary embodiment, discharge nozzle 310 may be a part of or replace a hydration system 270 as illustrated in FIGS. 1 through 8. In this regard, discharge nozzle 310 may be equivalent to misting device 274 or may be used in addition to misting device 274. Although one exemplary configuration of discharge nozzle 310 is described herein, it should be appreciated that discharge nozzle 310 may include any other suitable number, type, configuration, and position of devices for supplying water, hydration, sanitizing spray, nutrients, etc. to plants 124 or other portions of gardening appliance 100.

As shown, discharge nozzles 310 may be fluidly coupled to supply conduit 302 and may be positioned at desired locations within gardening appliance 100. For example, as illustrated, hydration system 308 has a plurality of discharge nozzles 310 for directing flow of water 306 into grow chamber 122, onto plants 124, and/or onto other surfaces within liner 120. Thus, discharge valve 308 may be coupled to supply conduit 302 for regulating the flow of water 306 therethrough. In addition, or alternatively, discharge valves 308 may be operably coupled directly to discharge nozzles 310 for selectively regulating the flow of liquid therethrough (i.e., the flow of water 306). Although a single discharge valve 308 is illustrated as regulating the flow of water 306 to all discharge nozzles 310, it should be appreciated that hydration system 300 may include a plurality of independently adjustable discharge valves that can provide the flow of liquid to specific plants according to specific hydration schedules.

According to exemplary embodiments, hydration system 300 may further include a nutrient dosing system 320 that is generally configured for facilitating the distribution of nutrient-rich liquid (identified herein generally by reference numeral 322) throughout gardening appliance 100 for improved plant growth. In this regard, for example, nutrient dosing system 320 may include a nutrient supply 324 and a mixing system (e.g., such as a mixing tank 326, described below in more detail) that provides a flow of nutrients 322 in the desired concentrations. Nutrient dosing system 320 may include replaceable nutrient cartridges that are filled with nutrients in concentrated form or may receive a nutrient supply from any other suitable location.

According to the illustrated embodiment, hydration system 300 may further include a mixing tank 326 that is generally configured for receiving water 306 from water supply 304 along with nutrients 322 from nutrient dosing system 320. Mixing tank 326 may include any suitable agitators, stirrers, or other devices for creating a nutrient mixture out of nutrients 322 and water 306. Although nutrient dosing system 320 is illustrated as being fluidly coupled to hydration system 300 upstream mixing tank 326, it should be appreciated that nutrient dosing system 320 may be fluidly coupled to hydration system 300 in any other suitable location and in any other suitable manner.

As used herein, the term “nutrients” and the like are intended generally to refer to any substances which facilitate improved growth of plants 124. For example, according to exemplary embodiments, nutrients may include calcium, magnesium, potassium, sulfur, copper, zinc, boron, molybdenum, iron, cobalt, manganese, phosphorous, and chlorine. Nutrients may also be used to refer to chemicals or substances that can be used to adjust a pH of the flow of liquid, a level of total dissolved solids (TDS), etc. According to alternative embodiments, any other suitable mixture or combination of compositions for encouraging root growth and plant growth may be used while remaining within the scope of the present subject matter.

Nutrient dosing system 320 may further include features for discharging selected flow rates or volumes of nutrients 322, such as pumps or discharge mechanisms. According to exemplary embodiments, nutrient dosing system 320 may include a plurality of solenoid-actuated plunger valves, a dedicated pump (e.g., such as a peristaltic pump), or a flow regulating valve that may selectively dispense any desired nutrients, at desired rates, and at desired times. Thus, nutrient dosing system 320 provides any suitable number, type, and combinations of nutrients 322 at any suitable flow rates and volumes for mixing within hydration system 300. For example, according to exemplary embodiments, nutrient dosing system 320 may include a plurality of flow regulating valves, discharge mechanisms, pumps, and supply nozzles that are all in operative communication with controller 174 of gardening appliance 100. As such, controller 174 may make informed decisions regarding the desired flow of diluted nutrient mixture based on the type, quality, and position of plants 124 within grow module 200. For example, controller 174 may regulate the type of nutrients supplied, the nutrient concentrations, which nozzles receive the flow of diluted nutrients, etc. In addition, nutrient dosing system 320 may make other adjustments that facilitate improved plant growth and ecosystem health within gardening appliance 100.

Referring still to FIG. 9, in various embodiments, gardening appliance 100 may include a cleaning assembly 330 is fluidly coupled to hydration system 300 for selectively discharging a cleaning agent (e.g., identified in FIG. 9 by reference numeral 332) into grow chamber 122, e.g., via discharge nozzles 310. More specifically, according to the illustrated embodiment, cleaning assembly 330 provides the cleaning agent 322 into mixing tank 326 where it may be mixed with the flow of water 306 to achieve the desired concentration of cleaning agent before facilitating a cleaning cycle. As best shown in FIG. 9, this mixture of the flow of water 306, the flow of nutrients 322, and/or the flow of cleaning agent 332 may be identified generally as cleaning solution 334. As shown, cleaning solution 334 may be directed through discharge nozzles 310 on the various surfaces within gardening appliance 100 and/or directly onto plants 124. In general, cleaning solution 334 may be a mild solution that helps to kill bacteria, germs, fungi, and other potentially harmful or undesirable contaminants introduced onto the plants 124 during the growth process or onto other portions of gardening appliance. In addition, cleaning solution 334 may generally be safe for user interaction and intermittent contact.

In general, cleaning agent 332 may be provided from any suitable source and may be regulated in any suitable manner. For example, according to the illustrated embodiment, cleaning assembly 330 includes one or more cartridges 336 that contain concentrated cleaning agent 332. In addition, cleaning assembly 330 may include an injection mechanism 338 that is generally configured for selectively discharging cleaning agent 332, e.g., at the desired volumes and/or flow rates. Specifically, according to the illustrated embodiment, injection mechanism 338 may be a flow regulating valve 340. In this regard, cartridges 336 be fluidly coupled to mixing tank 326 through a cleaning agent conduit 342 and may be pressurized or may be discharged via a pump or plunger mechanism. Flow regulating valve 340 may be fluidly coupled to cleaning agent conduit 342 and may be selectively regulated to control the flow of cleaning agent 332. According to still other embodiments, cleaning assembly 330 may include any suitable number, type, and configuration of pumping systems, gravity feed systems, or any other suitable flow regulating devices.

It should be appreciated that the cleaning agent 332 may be any suitable chemical, composition, or other mixture suitable for facilitating a cleaning cycle as described herein. Notably, however, it may be desirable to use cleaning agents 332 that do not include harsh chemicals, are safe for the growing environment, and/or are not otherwise hazardous in composition or concentration. For example, according to exemplary embodiments of the present subject matter, cleaning agent 332 may include hydrogen peroxide (H₂O₂), bleach, vinegar, or any other suitable cleaning agent. In addition, it should be appreciated that cleaning agent 332 may be stored at any suitable concentration and may be mixed within mixing tank 326 to achieve any suitable concentration prior to dispensing throughout gardening appliance 100 via discharge nozzles 310. For example, according to exemplary embodiments, cartridges 336 may store a cleaning agent 332 at a concentration of between about 3% and 6% hydrogen peroxide. In general, cleaning agent 332 may be dispensed in a manner similar to nutrients 322.

For example, after mixing within mixing tank 326, the concentration of hydrogen peroxide within cleaning solution 334 may be between about 0.0001% and 1%, between about 0.001% and 0.1%, between about 0.01% and 0.05%, or any other suitable concentration of hydrogen peroxide. More specifically, for example, these solutions may be used for a conventional self-clean cycle (e.g., as described in more detail below). In addition, or alternatively, gardening appliance 100 may be programmed to periodically perform a deep-clean cycle which may vary from the standard self-clean cycle in terms of the duration of spray, the concentration of cleaning solution 334, the chemicals used, etc. For example, deep-clean cycles may use hydrogen peroxide concentrations of between about 0.1% and 6%, between about 0.5% and 3%, between about 1% and 2%, or any other suitable concentration.

Referring still to FIG. 9, hydration system 300 may further include features for collecting, discharging, and/or recirculating the flow of cleaning solution 334 or other liquid within grow chamber 122. In this regard, plants 124 may not absorb all of the flow of liquid provided from hydration system 300 dispensed from discharge nozzles 310. Therefore, the excess liquid may drip off of plants 124 and collect at the bottom of gardening appliance 100. Thus, according to the illustrated embodiment, hydration system 300 includes a sump 350 that is generally configured for collecting liquid (e.g., referred to herein as drainage water 352) from within grow chamber 122.

Hydration system 300 may further include a wastewater reservoir or tank 354 that is fluidly coupled to sump 350 for storing drainage water 352. According to exemplary embodiments, wastewater reservoir 354 may be removable from gardening appliance 100, such that a user may periodically empty or drain wastewater reservoir 354 through an external drain, such as a kitchen sink. According to still other embodiments, wastewater reservoir 354 may be connected to an external drain via a flow regulating valve and/or a drainage pump for periodically or selectively discharging drainage water 352 from wastewater reservoir 354.

Notably, in order to prevent overfilling of wastewater reservoir 354, gardening appliance 100 may include features for ensuring that the available storage capacity of wastewater reservoir 354 is sufficient for storing liquid generated during a sanitization cycle prior to initiation of the sanitization cycle. As such, as best shown in FIG. 9, wastewater reservoir 354 may further include a water level sensor 356 that is positioned within wastewater reservoir 354 for measuring a level of drainage water 352 therein. In this manner, feedback from water level sensor 356 may be used to determine when a sanitization cycle may be performed without risking the overflow of wastewater reservoir 354. Level sensor 356 can be any suitable type of sensor, such as a float switch, an optical switch, a capacitance-based level sensor, etc.

In general, controller 174 of gardening appliance 100 may be configured for regulating operation of hydration system 300, including cleaning assembly 330 and nutrient dosing system 320. In this regard, controller 174 may be configured to receive a command to commence a cleaning cycle. As used herein, the terms “cleaning cycle” and the like are generally intended to refer to any period of operation when cleaning assembly 330 is providing the flow of cleaning agent 332 into mixing tank 326 to facilitate a cleaning or sanitization cycle of plants 124 or other surfaces within gardening appliance 100.

According to exemplary embodiments, the command to commence a cleaning/sanitization cycle may be received from a user of gardening appliance 100. In this regard, for example, control panel 170 may include a user input 172 that a user may select to initiate a cleaning cycle. According to exemplary embodiments, controller 174 may be in operative communication with a remote device (e.g., such as external device 182), such as a mobile phone running a software application that may be used to input the command to commence a cleaning cycle. According to alternative embodiments, the command to commence a cleaning cycle may be generated periodically by the controller 174 or may otherwise be operated according to a preprogrammed schedule that may be manipulated by a user, set by a manufacturer, etc. This cleaning cycle is generally intended for maintaining the plants in a clean growing environment within gardening appliance 100 and/or otherwise maintaining a clean condition of all surfaces of gardening appliance 100.

Controller 174 may further be configured for determining that a self-clean condition is satisfied prior to commencing a cleaning cycle. In general, the self-clean condition is satisfied when a self-clean cycle needs to be run within gardening appliance 100. In this regard, self-clean cycles are typically preferably run at fixed intervals, e.g., to remove build-up or grime formed during each particular interval. For example, it may be desirable to run a self-clean cycle once every 2 to 20 days, once every 5 to 10 days, about once every week, or at any other suitable time interval.

According to exemplary embodiments, these self-cleaning conditions or desired cleaning intervals may be set by a user of the appliance, e.g., through interaction with control panel 170, through a software application on a remote device 182, etc. In addition, it should be appreciated that the self-cleaning condition may be based on time intervals between cycles, e.g., such that the self-clean condition is satisfied if a predetermined amount of time has elapsed since the last recorded self-clean cycle. These self-clean time intervals may be similarly determined in any set by a user, e.g., based on the desired level of cleanliness. Alternatively these intervals may be programmed by the appliance manufacturer or may be determined in any other suitable manner.

Controller 174 may also be programmed to commence a deep-cleaning cycle when a deep-clean condition is satisfied. In this regard, for example, a deep-clean cycle may generally refer to a cleaning cycle that is more rigorous than the standard self-clean cycle described above. For example, the deep-clean cycle may last longer, may include a higher concentration of cleaning agent 332, may be operated at higher flow pressures through discharge nozzles 310, etc. Due to the rigorous nature of the deep-clean cycle, gardening appliance 100 may include features for determining that no plants are present during the deep-clean cycle. For example, the gardening appliance 100 may use a camera assembly, a weight sensor, trigger switches, or any other suitable device to confirming there are no plants currently growing. In addition, or alternatively, the controller 174 may communicate with a user of the appliance via control panel 170 to receive confirmation of an empty grow chamber 122 prior to initiation of the deep-clean cycle. In this manner, the deep-clean cycle may safely use higher concentrations of cleaning agent 332 and a more rigorous or extensive cleaning process to thoroughly clean internal surfaces of gardening appliance 100, such as walls of liner 120 or grow module 200, discharge nozzles 310, mixing tank 326, etc.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. An indoor gardening appliance, comprising:
a liner positioned within a cabinet and defining a grow chamber;
a grow module mounted within the liner and defining a plurality of apertures for receiving one or more plant pods;
a hydration system comprising a water supply for providing a flow of water and a discharge nozzle for selectively discharging the flow of water into the grow chamber; and
a cleaning assembly fluidly coupled to the hydration system for selectively discharging a cleaning agent into the flow of water to create a cleaning solution to facilitate a self-clean cycle.

2. The indoor gardening appliance of claim 1, wherein the cleaning assembly comprises:
one or more cartridges containing the cleaning agent; and
an injection mechanism for selectively discharging the cleaning agent from the one or more cartridges into the flow of water to create the cleaning solution.

3. The indoor gardening appliance of claim 2, wherein the injection mechanism comprises at least one of a flow regulating valve or a pump.

4. The indoor gardening appliance of claim 1, wherein the hydration system further comprises:
a mixing tank fluidly coupled to the water supply through a water supply conduit and the cleaning assembly through a cleaning agent conduit.

5. The indoor gardening appliance of claim 1, wherein the cleaning agent comprises hydrogen peroxide.

6. The indoor gardening appliance of claim 5, wherein a concentration of the hydrogen peroxide during the self-clean cycle is between about 0.001% and 0.1%.

7. The indoor gardening appliance of claim 1, wherein the cleaning agent comprises bleach or vinegar.

8. The indoor gardening appliance of claim 1, further comprising a controller configured to:
determine that a self-clean condition is satisfied; and
commence the self-clean cycle in response to determining that the self-clean condition is satisfied.

9. The indoor gardening appliance of claim 8, wherein determining that the self-clean condition is satisfied comprises:
determining that a predetermined amount of time has passed since a prior self-clean cycle.

10. The indoor gardening appliance of claim 9, wherein the predetermined amount of time is between about 5 days and 10 days.

11. The indoor gardening appliance of claim 8, wherein determining that the self-clean condition is satisfied comprises:
receiving a user command to initiate the self-clean cycle.

12. The indoor gardening appliance of claim 11, further comprising:
a user interface panel, wherein the user command is provided through the user interface panel.

13. The indoor gardening appliance of claim 11, wherein the controller is in operative communication with a remote device through an external network, and wherein the user command is provided through the remote device.

14. The indoor gardening appliance of claim 8, wherein the controller is further configured to:
determine that a deep-clean condition is satisfied; and
commence a deep-clean cycle in response to determining that the deep-clean condition is satisfied.

15. The indoor gardening appliance of claim 14, wherein determining that the deep-clean condition is satisfied comprises:
determining that a predetermined amount of time has passed since a prior deep-clean cycle; and
determining that the grow chamber does not contain any plants.

16. The indoor gardening appliance of claim 14, wherein the deep-clean cycle comprises at least one of an extended cleaning time or a higher concentration of the cleaning agent relative to the self-clean cycle.

17. The indoor gardening appliance of claim 1, wherein the hydration system further comprises:
a sump positioned at a bottom of the grow chamber for collecting drainage water; and
a wastewater reservoir fluidly coupled to the sump for storing the drainage water.

18. A hydration system for an indoor gardening appliance, the indoor gardening appliance comprising a cabinet defining a grow chamber for receiving plants, the hydration system comprising:
a mixing tank fluidly coupled to a water supply for receiving a flow of water;
a discharge nozzle for selectively discharging the flow of water into the grow chamber; and
a cleaning assembly comprising:
one or more cartridges containing a cleaning agent; and
an injection mechanism for selectively discharging the cleaning agent from the one or more cartridges into the flow of water to create a cleaning solution to facilitate a self-clean cycle.

19. The hydration system of claim 18, further comprising a controller configured to:
determine that a self-clean condition is satisfied; and
commence the self-clean cycle in response to determining that the self-clean condition is satisfied.

20. The hydration system of claim 18, wherein the cleaning agent comprises at least one of hydrogen peroxide, bleach, or vinegar.
